(19) United States
(12) Patent Application Publication
(10) Pub. No.: US 2025/0291369 A1
(43) Pub. Date: Sep. 18, 2025

(54) OSCILLATING FLOW CONTROLLER

(71) Applicant: IPLEXXUS HOLDINGS, LLC, Freeland, MI (US)

(72) Inventor: David A. DZIOBA, Freeland, MI (US)

(21) Appl. No.: 19/081,559

(22) Filed: Mar. 17, 2025

Related U.S. Application Data
(60) Provisional application No. 63/566,579, filed on Mar. 18, 2024.
(60) Provisional application No. 63/652,453, filed on May 28, 2024.

(51) Int. Cl. G05D 7/01

(52) U.S. Cl. CPC G05D 7/0153

(57) ABSTRACT

An oscillating flow controller includes a housing, a first valve operable between first and second positions, a second valve operable between first and second positions, and a biasing mechanism configured to simultaneously bias both the first and second valves toward their respective first positions or second positions. The housing, the first valve, and the second valve cooperate to define a first pilot chamber and a second pilot chamber. When the first and second valves are in their respective first positions, they disable fluid flow into the first pilot chamber and out of the second pilot chamber, while enabling fluid flow out of the first pilot chamber and into the second pilot chamber. When the first and second valves are in their respective second positions, they enable fluid flow into the first pilot chamber and out of the second pilot chamber, while disabling fluid flow out of the first pilot chamber and into the second pilot chamber. The first and second valves change state in response to supply of pressurized fluid to the first and second pilot chambers through the first valve.

### BACKGROUND OF THE DISCLOSURE

Control systems for operating systems of accumulators, for example without limitation, selectively and inflatable compartments of therapeutic support surfaces or support surface overlays can be costly, bulky, and complicated to use. For example, such control systems can include, among other components, pumps, solenoid valves, electronic control units configured to control the pumps and the solenoid valves, and a housing containing the foregoing components.

Each of these components may in itself be costly, and further cost may lie in the assembly thereof to create the control systems.

Also, the assembled control systems, even if relatively compact, may nevertheless compete for space in an otherwise crowded environment, for example, an operating room or patient room in a hospital. One skilled in the art would understand that such environments typically includes numerous forms of other equipment required for patient support, monitoring, and comfort.

Further, many known control systems allow a user to establish and/or control programs for operating the accumulators. Such programmability, however, can be complicated to implement and may be unnecessary in many applications. In fact, once such a control system's operational parameters have been initially set, it is likely that such settings will be changed only rarely, if at all.

It would be desirable to provide a less costly, less bulky, and less complicated apparatus or system for operating such systems of accumulators.

### SUMMARY OF THE DISCLOSURE

The disclosure is directed to an oscillating flow controller including a housing, a first valve operable between a first position and a second position, a second valve operable between a first position and a second position, and a biasing mechanism configured to simultaneously bias both of the first valve and the second valve toward their respective first positions or toward their respective second positions. The housing, the first valve, and the second valve cooperate to define a first pilot chamber and a second pilot chamber. The first valve is configured to: (i) disable fluid communication through a first fluid inlet into the first pilot chamber and enable fluid communication through a second fluid inlet into the second pilot chamber when the first valve is in the first position; and (ii) enable fluid communication through the first fluid inlet into the first pilot chamber and disable fluid communication through the second fluid inlet into the second pilot chamber when the first valve is in the second position. The second valve is configured to: (i) enable fluid communication through a first fluid outlet from the first pilot chamber and disable fluid communication through a second fluid outlet from the second pilot chamber when the second valve is in the first position; and (ii) disable fluid communication through the first fluid outlet from the first pilot chamber and enable fluid communication through the second fluid outlet from the second pilot chamber when the second valve is in the second position.

In an embodiment, the first valve may include a first armature having a first and a second end movably received within a first armature chamber defined by the housing. The first armature may be configured to move between first and second positions within the first armature chamber so that, when the first armature is in the first position, the first end of the first armature cooperates with the housing to disable fluid communication through the first fluid inlet from the first armature chamber to the first pilot chamber, and the second end of the first armature may cooperate with the housing to enable fluid communication through the second fluid inlet to the second pilot chamber, and so that, when the first armature is in the second position, the first end of the first armature may cooperate with the housing to enable fluid communication through the first fluid inlet from the first armature chamber to the first pilot chamber, and the second end of the first armature may cooperate with the housing to disable fluid communication between the first armature chamber and the second fluid inlet.

In an embodiment, the second valve may include a second armature having a first and a second end movably received within a second armature chamber defined by the housing, a first pressure barrier defining a first aperture and movable between a first position and a second position, and a second pressure barrier defining a second aperture and movable between a first position and a second position. The second armature may be configured to move between first and second positions within the second armature chamber so that, when the second armature is in the first position, the first end of the second armature cooperates with the first pressure barrier to enable fluid communication through the first aperture from the first pilot chamber to the second armature chamber, and the second end of the second armature cooperates with the second pressure barrier to disable fluid communication through the second aperture from the second pilot chamber to the second armature chamber, and so that, when the second armature is in the second position, the first end of the second armature cooperates with the first pressure barrier to disable fluid communication through the first aperture from the first pilot chamber to the second armature chamber, and the second end of the second armature cooperates with the second pressure barrier to enable fluid communication through the second aperture from the second pilot chamber to the second armature chamber.

The first pressure barrier and the second pressure barrier may be configured to move in response to movement of the second armature. The second armature may be configured to move in response to movement of one or both of the first pressure barrier and the second pressure barrier. Introduction of a pressurized fluid to the second fluid inlet when the first and second valves are in their respective first positions may cause the second pressure barrier to move and thereby move the second armature toward its second position. The biasing mechanism, in response to the movement of the second armature toward its second position, may bias the first armature and the second armature toward their respective second positions. Introduction of a pressurized fluid to the first fluid inlet when the first and second valves are in their respective second positions may cause the first pressure barrier to move and thereby move the second armature toward its first position. The biasing mechanism, in response to the movement of the second armature toward its first state, may bias the first armature and the second armature toward their respective first positions.

The first pressure barrier and/or the second pressure barrier may be flexible and resilient. The first pressure barrier and/or the second pressure barrier may be a diaphragm. The first pressure barrier and/or the second pressure barrier may be a bellows.

The biasing mechanism may comprise a first magnet connected to the first armature and a second magnet connected to the second armature, wherein the first magnet and the second magnet are configured to repel each other. The first armature may surround the second armature. The first armature chamber may surround the second armature chamber, and a portion of the housing may separate the first armature chamber from the second armature chamber.

The oscillating flow controller may further include a first flow restrictor located in the first pilot chamber between the first valve and the second valve to thereby divide the first pilot chamber into a first section proximate the first valve and a second section proximate the second valve.

The housing may further defines a first bidirectional port in fluid communication with the first pilot chamber. The first bidirectional port may be configured for connection to a first external accumulator. A first flow restrictor may be located in the first pilot chamber between the first valve and the second valve to thereby divide the first pilot chamber into a first section proximate the first valve and the first bidirectional port and a second section distant from the first valve and the first bi-directional port.

The housing may further define a second bidirectional port in fluid communication with the second pilot chamber. The second bidirectional port may be configured for connection to a second external accumulator.

The oscillating flow controller may further include a travel limiter connected to the first movable pressure barrier and configured to limit movement of the first moveable pressure barrier with respect to the first pilot chamber or the second armature.

The oscillating flow controller may be part of a system including a fluid pump having a fluid outlet fluidly coupled to the first and second fluid inlets and a fluid inlet fluidly coupled to the first and second fluid outlets of the oscillating flow controller.

### BRIEF DESCRIPTION OF THE DRAWINGS

FIG. 1 is a side cross-sectional view of an illustrative oscillating flow controller having first and second armatures, first and second pilot chambers, and first and second movable pressure barriers, with the first and second armatures in respective first positions according to the present disclosure;

FIG. 2 is a side cross-sectional view of the oscillating flow controller of FIG. 1 with the first and second armatures in respective second positions;

FIG. 3A is a perspective view of the first and second armatures of the oscillating flow controller of FIG. 1;

FIG. 3B is a perspective view of the first and second armatures of the oscillating flow controller of FIG. 1 further showing first and second travel limiters operably associated with the second armature;

FIG. 3C is a perspective view of the first and second armatures and first and second travel limiters of the oscillating control valve of FIG. 1 wherein the first and second movable pressure barriers are embodied as first and second flexible diaphragms connected to the first and second travel limiters, respectively;

FIG. 3D is a perspective view of the first and second movable pressure barriers and the first and second travel limiters of the oscillating control valve of FIG. 1 apart from the first and second armatures thereof;

FIG. 4A is a side elevation view of the first and second armatures, the first and second movable pressure barriers, and the first and second travel limiters of the oscillating control valve of FIG. 1, wherein the first and second movable pressure barriers are embodied as first and second flexible diaphragms;

FIG. 4B is a side elevation view of first and second armatures of the oscillating control valve of FIG. 1, wherein the first and second movable pressure barriers are embodied as first and second flexible bellows;

FIG. 5A is a perspective view of the first armature of the oscillating control valve of FIG. 1;

FIG. 5B is an exploded perspective view of the first armature of the oscillating control valve of FIG. 1;

FIG. 6A is a perspective view of the second armature of the oscillating control valve of FIG. 1;

FIG. 6B is an exploded perspective view of the second armature of the oscillating control valve of FIG. 1;

FIG. 7 is a perspective view of a first permanent magnet of the first armature concentrically surrounding a second permanent magnet of the second armature of the oscillating control valve of FIG. 1 wherein respective magnetic centers of the first and second permanent magnets are aligned;

FIG. 8A is a block diagram showing schematically the oscillating control valve of FIG. 1 in combination with a source of pressurized fluid connected to a fluid supply port thereof, a first external accumulator connected to a first bi-directional fluid port thereof, and a second external accumulator connected to a second bi-directional fluid port thereof;

FIG. 8B is a block diagram similar to the block diagram of FIG. 8A, further showing a fluid outlet port of the oscillating flow controller fluidly coupled to a fluid inlet of the source of pressurized fluid and to a vacuum breaker;

FIG. 9 is a side cross-sectional view of the oscillating control valve of FIG. 1 in combination with the source of pressurized fluid connected to the fluid supply port thereof, a first external accumulator connected to the first bi-directional fluid port thereof, and a second external accumulator connected to the second bi-directional fluid port thereof, with the first and second armatures of the oscillating control valve in respect first positions;

FIG. 10 is a side cross-sectional view of the oscillating control valve of FIG. 1 in combination with the source of pressurized fluid connected to the fluid supply port thereof, the first external accumulator connected to the first bi-directional fluid port thereof, and the second external accumulator connected to the second bi-directional fluid port thereof, with the first and second armatures of the oscillating control valve in respect second positions;

FIGS. 11-18 are side cross-sectional views of the oscillating control valve of FIG. 1 in an illustrative sequence of operational states when used in an illustrative manner in combination with the source of pressurized fluid and the first and second external accumulators, wherein:

FIG. 11 shows the oscillating control valve of FIG. 1 in a first operational state;

FIG. 12 shows the oscillating control valve of FIG. 1 in a second operational state;

FIG. 13 shows the oscillating control valve of FIG. 1 in a third operational state;

FIG. 14 shows the oscillating control valve of FIG. 1 in a fourth operational state;

FIG. 15 shows the oscillating control valve of FIG. 1 in a fifth operational state;

FIG. 16 shows the oscillating control valve of FIG. 1 in a sixth operational state;

FIG. 17 shows the oscillating control valve of FIG. 1 in a seventh operational state;

FIG. 18 shows the oscillating control valve of FIG. 1 in an eighth operational state; and

FIGS. 19A-19D are timing diagrams reflecting illustrative pressurization and depressurization of one or more external accumulators fluidly connected to the oscillating control valve of FIG. 1.

### DETAILED DESCRIPTION OF THE DRAWINGS

The drawings show an illustrative embodiment of an oscillating flow controller 10 (which may be referred to herein as an “oscillator”) and an illustrative use and operation of the same according to the present disclosure. The oscillator 10 includes a housing 12 defining a fluid supply port 14, a first bidirectional fluid port 16, a second bidirectional fluid port 18, a fluid exhaust port 20 (the drawings show two fluid exhaust ports 20 but only one is required), a first armature chamber 22 fluidly connected with the fluid supply port 14, a second armature chamber 24 fluidly connected with the fluid exhaust port(s) 20, a first cavity 26 fluidly connected with a first end of the second armature chamber 24, and a second cavity 28 fluidly connected with a second end of the second armature chamber 24. In embodiments, either or both of the first bidirectional port 16 and the second bidirectional port 18 may be eliminated, plugged, or otherwise deadheaded, as will be discussed further below.

As shown, the first armature chamber 22 is generally annular, and the second armature chamber 24 is stepped-cylindrical and generally concentric (or coaxial) with the first armature chamber 22. In embodiments, the first armature chamber 22 and the second armature chamber 24 may have other shapes. The first armature chamber 22 extends peripherally about at least a portion of the second armature chamber 24.

The first cavity 26 extends in a first axial direction D1 from a first end of the second armature chamber 24. The second cavity 28 extends in a second axial direction D2 from a second end of the second armature chamber 24. The first axial direction D1 is opposite the second axial direction D2.

A first fluid channel 30 fluidly connects the first armature chamber 22 with the first cavity 26. A second fluid channel 32 fluidly connects the first armature chamber 22 with the second cavity 28. A third fluid channel 34 fluidly connects the first fluid channel 30 with the first bidirectional port 16. In embodiments omitting the first bidirectional port 16, the third fluid channel 34 may be omitted, as well. A fourth fluid channel 36 fluidly connects the second fluid channel 32 with the second bidirectional port 18. In embodiments omitting the second bidirectional port 18, the fourth fluid channel 36 may be omitted, as well. A fluid exhaust channel 20C fluidly connects the second armature chamber 24 with the fluid exhaust port 20.

As shown, an optional first flow-restricting orifice 38 may be disposed in the first fluid channel 30, and an optional second flow-restricting orifice 40 may be disposed in the second fluid channel 32. The optional first Similarly, in embodiments, optional flow-restricting orifices could be installed in any fluid channel within the oscillator 10, for example, without limitation, any or all of the first and second fluid channels 30, 32, a fluid supply channel 14C and the fluid exhaust channel(s) 20C. In embodiments, any or all such flow-restricting orifices may be adjustable. Such optional flow-restricting orifices may be provided and sized as desired as factors contributing to the oscillation frequency of the flow oscillator 10, as will be discussed further below and as would be understood by one skilled in the art.

The oscillator 10 also includes a first movable pressure barrier 42 disposed in the first cavity 26 so as to divide the first cavity 26 into a first compartment 26A proximate the second armature chamber 24 and a second compartment 26B distant from the second armature chamber 24. The first movable pressure barrier 42 defines a first aperture 44 therein through which fluid may selectively flow between the first compartment 26A and the second compartment 26B, as will be discussed further below. At least a portion of the first movable pressure barrier 42 may be flexible and/or resilient.

Similarly, the oscillator 10 includes a second movable pressure barrier 52 disposed in the second cavity 28 so as to divide the second cavity 28 into a first compartment 28A proximate the second armature chamber 24 and a second compartment 28B distant from the second armature chamber 24. The second movable pressure barrier 52 defines a second aperture 54 therein through which fluid may selectively flow between the first compartment 28A and the second compartment 28B. At least a portion of the second movable pressure barrier 52 may be flexible and/or resilient.

The second compartment 26B of the first cavity 26 alone or in combination with the first fluid channel 30 and the third fluid channel 34 (if provided) comprises a first pilot chamber and may be referred to herein as the first pilot chamber 26B. Similarly, the second compartment 28B of the second cavity 28 alone or in combination with the second fluid channel 32 and the fourth fluid channel 36 (if provided) comprises a second pilot chamber and may be referred to herein as the second pilot chamber 28B.

The respective volumes of the first and second pilot chambers 26B, 28B may be sized as desired as factors contributing to the oscillation frequency of the oscillator 10, as will be discussed further below and as would be understood by one skilled in the art.

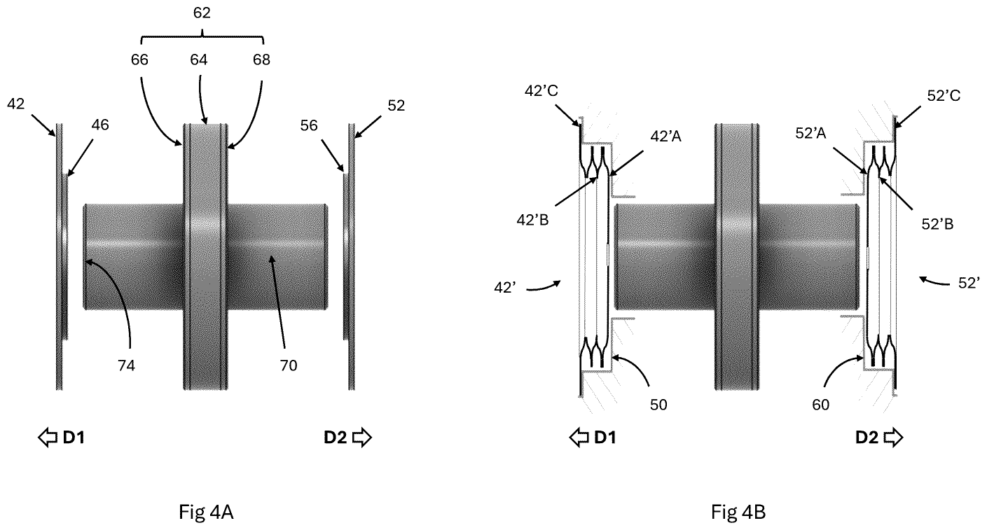

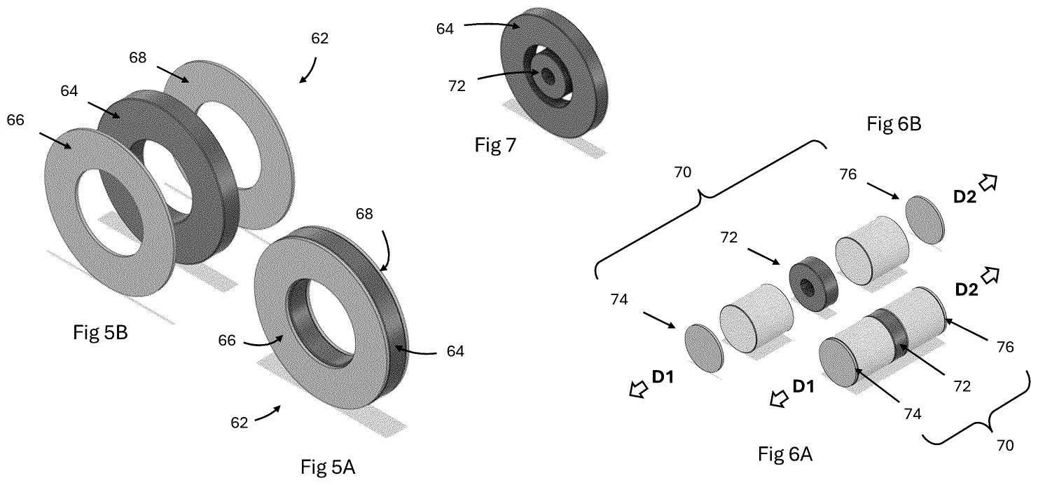

As shown generally in the drawings, the first and second movable pressure barriers 42, 52 may be embodied as first and second flexible diaphragms 42, 52. As shown in FIG. 4B, the first and second movable pressure barriers may be embodied as first and second flexible bellows 42′, 52′. In embodiments one of the first and second movable pressure barriers 42, 52 could be embodied as a flexible diaphragm, and the other could be embodied as a flexible bellows. One skilled in the art would recognize that the first and second movable pressure barriers 42, 52 could be embodied in other ways, as well.

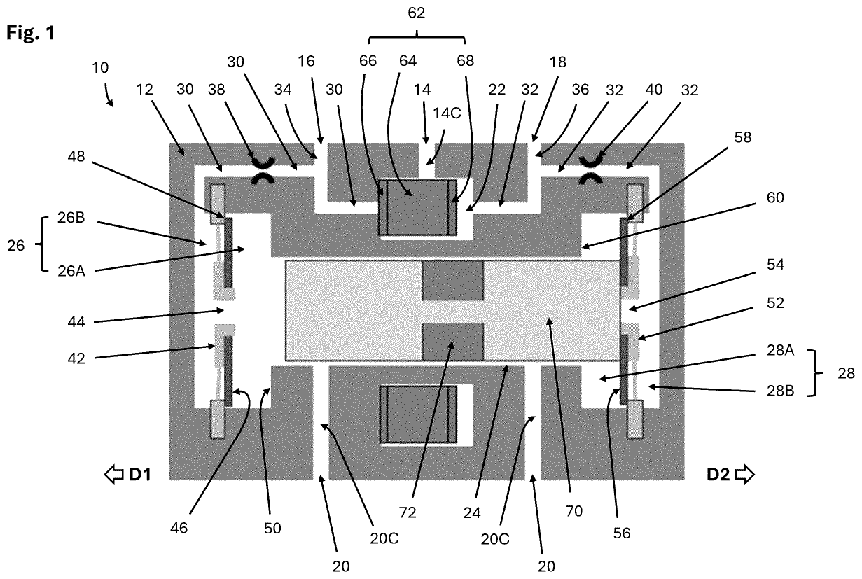

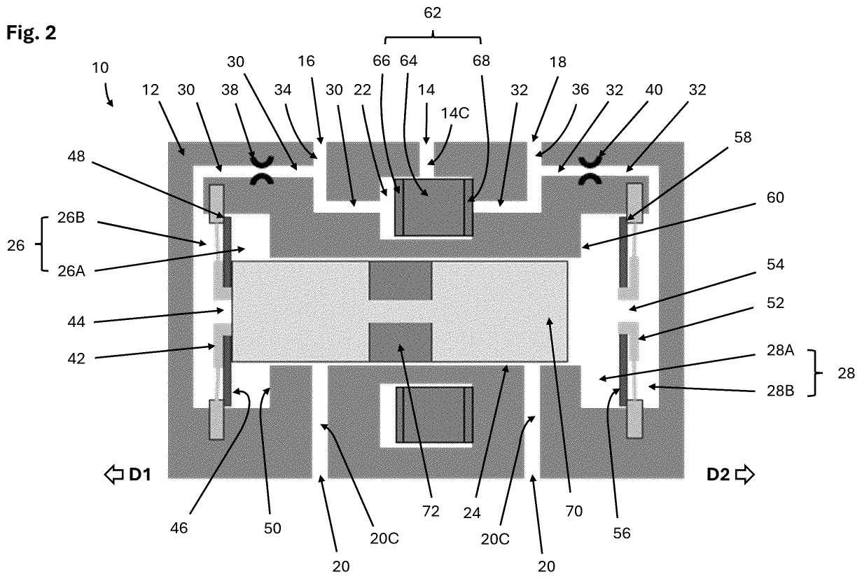

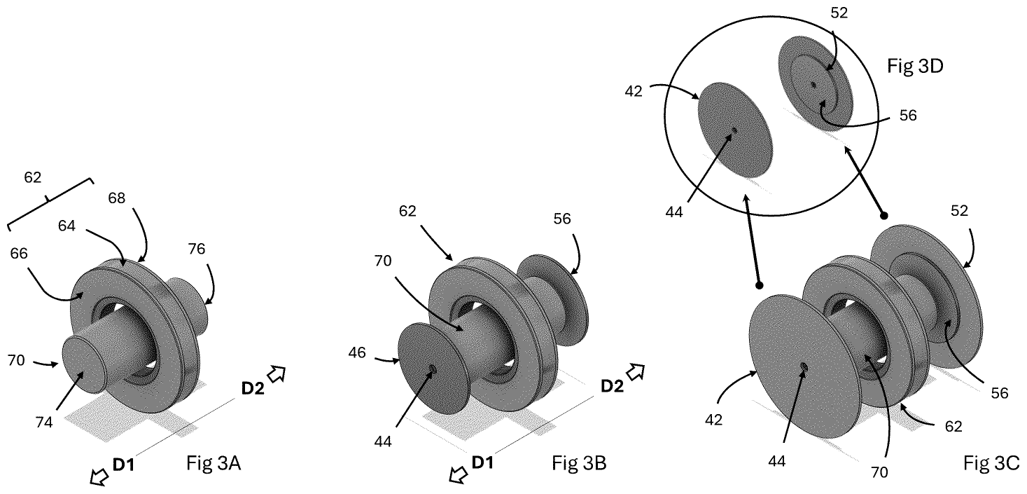

The oscillator 10 further includes a first armature 62 slidingly received within the first armature chamber 22. The first armature 62 has a first end and a second end opposite the first end. The first end of the first armature 62 faces the first direction D1, and the second end of the first armature 62 faces the second direction D2. A first permanent magnet 64 is disposed in a central region of the first armature 62 between the first and second ends thereof. The first permanent magnet 64 may be fixed to the first armature 62. The first end of the first armature 62 is configured to selectively and sealingly occlude the first fluid channel 30. For example, as may be best shown in FIG. 1, the first end of the first armature 62 is configured selectively and sealingly engage with a first wall of the first armature chamber 22 opposite the first end of the first armature and defining a corresponding end of the first fluid channel 30 to thereby occlude the first fluid channel 30. Similarly, the second end of the first armature 62 is configured to selectively and sealingly occlude the second fluid channel 32. For example, as may be best shown in FIG. 2, the second end of the first armature 62 is configured to selectively and sealingly engage with a second wall of the first armature chamber 22 opposite the second end of the first armature 62 and defining a corresponding end of the second fluid channel 32.

In embodiments, one or more seals may be provided to facilitate sealing engagement of the first armature 62 with the first and second walls of the first armature chamber 22. For example as shown, the first end of the first armature 62 includes a first face seal 66, and the second end of the first armature 62 includes a second face seal 68. In embodiments, the first face seal 66 may instead be integrated with the housing 12 opposite the first end of the first armature 62 and be configured to selectively and sealingly engage the first end of the first armature 62. Similarly, the second face seal 68 may instead be integrated with the housing 12 opposite the second end of the first armature 62 and be configured to selectively and sealingly engage the second end of the first armature 62. In embodiments, other forms of seals (not shown) may be provided in addition to or instead of the foregoing face seals.

The first armature 62 is configured to slide axially within the first armature chamber 22 in the first and second directions D1, D2 between a first position and a second position. The first armature 62 is configured to resist or block fluid flow between the first armature chamber 22 and the first fluid channel 30, and to enable flow between the first armature chamber 22 and the second fluid channel 32 when the first armature 62 is in the first position. Also, the first armature 62 is configured to enable fluid flow between the first armature chamber 22 and the first fluid channel 30, and to resist or block fluid flow between the first armature chamber 22 and the second fluid channel 32 when the first armature 62 is in the second position. More specifically, when the first armature 62 is in the first position, the first end of the first armature 62 (and the first face seal 66 if provided) engages a wall of the first armature chamber 22 defining the corresponding end of the first fluid channel 30 and occludes the end of the first fluid channel 30, while the second end of the first armature 62 is spaced from a wall of the first armature chamber 22 defining the corresponding end of the second fluid channel 32. When the first armature 62 is in the second position, the first end of the first armature 62 is spaced from the wall of the first armature chamber 22 defining the corresponding end of the first fluid channel 30, while the second end of the first armature 62 (including the second face seal 68 if provided) engages the wall of the first armature chamber 22 defining the corresponding end of the second fluid channel 32 and occludes the second fluid channel 32. As such, the first armature 62 and the housing 12 cooperate to define a first multi-port valve. Also, as is evident from the drawings, a radial clearance between the first armature 62 and the housing 12 is sufficient to enable substantial fluid flow through the first armature chamber 22, between the first armature 62 and the housing 12 defining the first armature chamber 22.

Similarly, the oscillator 10 includes a second armature 70 slidingly received within the second armature chamber 24. The second armature 70 has a first end and a second end opposite the first end. The first end of the second armature 70 faces the first direction D1, and the second end of the second armature 70 faces the second direction D2. A second permanent magnet 72 is disposed in a central region of the second armature 70 between the first and second ends thereof. The second permanent magnet 72 may be fixed to the second armature 70. The first end of the second armature 70 is configured to selectively engage with an adjacent face of the first movable pressure barrier 42 and to thereby selectively occlude the first aperture 44. Similarly, the second end of the second armature 70 is configured to selectively engage with an adjacent face of the second movable pressure barrier 52 and to thereby selectively occlude the second aperture 54. The first end of the second armature 70 may include a first face seal 74, and the second end of the second armature 70 may include a second face seal 76. In embodiments, the first face seal 74 may be instead be integrated with the first movable pressure barrier 42 and configured to selectively and sealingly engage with first end of the second armature 70. Similarly, the second face seal 76 may be instead be integrated with the second movable pressure barrier 52 and configured to selectively and sealingly engage with the second end of the second armature 70. As such, the second armature 70, the first movable pressure barrier 42, and the second movable pressure barrier 52 cooperate to define a second multi-port valve. Also, as is evident from the drawings, a radial clearance between the second armature 70 and the housing 12 is sufficient to enable substantial fluid flow through the second armature chamber 24, between the second armature 70 and the housing 12 defining the second armature chamber 24.

The foregoing first and second multi-port valves and the housing may cooperate to define the first and second pilot chambers 26B, 28B. In embodiments including the first flow-restricting orifice 38, the first flow-restricting orifice 38 divides the first pilot chamber 26B into a first section proximate the first armature (and, therefore, the first multi-port valve) and a second section proximate the first movable pressure barrier 42 and the second armature 70 (and, therefore, the second multi-port valve). In embodiments including the second flow-restricting orifice 40, the second flow-restricting orifice 40 similarly divides the second pilot chamber 28B into a first section proximate the first armature (and, therefore, the first multi-port valve) and a second section proximate the first movable pressure barrier 42 and the second armature 70 (and, therefore, the second multi-port valve).

The second armature 70 is configured to slide axially within the second armature chamber 24 in the first and second directions D1, D2 between a first position and a second position. The second armature 70 is configured to resist or block fluid flow between the first and second compartments 28A, 28B of the second cavity 28 (and, therefore, between the second armature chamber 24 and the second pilot chamber 28B), and to enable flow between the first and second compartments 26A, 26B of the first cavity 26 (and, therefore, between the second armature chamber 24 and the first pilot chamber 26B) when the second armature 70 is in the first position. Also, the second armature 70 is configured to enable fluid flow between the first and second compartments 28A, 28B of the second cavity 28 (and, therefore, between the second armature chamber 24 and the second pilot chamber 28B), and to resist or block flow between the first and second compartments 26A, 26B of the first cavity 26 (and, therefore, between the second armature chamber 24 and the first pilot chamber 26B) when the second armature 70 is in the second position. More specifically, when the second armature 70 is in the first position, the second end of the second armature 70 (and the second face seal 76 if provided) engages the adjacent face of the second movable pressure barrier 52 and occludes the second aperture 54, while the first end of the second armature 70 is spaced from the first movable pressure barrier 42 and the first aperture 44. When the second armature 70 is in the second position, the second end of the second armature 70 is spaced from the second movable pressure barrier 52 and the second aperture 54, while the first end of the second armature 70 (including the first face seal 74 if provided) engages the adjacent face of the first movable pressure barrier 42 and occludes the first aperture 44.

In embodiments, the oscillator 10 may include a first travel limiter configured to restrict displacement of the first movable pressure barrier 42 relative to one or both of the first movable pressure barrier 42 and the housing 12. For example, and with reference to FIG. 4A, wherein the first movable pressure barrier 42 is shown as a first flexible diaphragm 42, the first travel limiter may be embodied as a first flange 46 adhered to or otherwise integrated with a central portion of the first flexible diaphragm 42 proximate the first aperture 44. The first flange 46 may be configured to engage a land 48 defined by a peripheral portion of the first flexible diaphragm 42 radially outward from the central portion and the first aperture 44 of the first flexible diaphragm 42 when the first flexible diaphragm 42 is displaced in the first direction D1, thereby limiting displacement of the first flexible diaphragm 42 in the first direction D1. Also, the housing 12 may define a land 50 configured to engage with the first flange 46 when the first flexible diaphragm 42 is displaced in the second direction D2, thereby limiting displacement of the first flexible diaphragm 42 in the second direction D2.

Similarly, the oscillator 10 may include a second travel limiter configured to restrict displacement of the second movable pressure barrier 52 relative to one or both of the second movable pressure barrier 52 and the housing 12. For example, and with continued reference to FIG. 4A, wherein the second movable pressure barrier 52 is shown as a second flexible diaphragm 52, the second travel limiter may be embodied as a second flange 56 adhered to or otherwise integrated with a central portion of the second movable pressure barrier 52 proximate the second aperture 54. The second flange 56 may be configured to engage a land 58 defined by a peripheral portion of the second movable pressure barrier 52 radially outward from the central portion and the second aperture 54 of the second movable pressure barrier 52 when the second movable pressure barrier 52 is displaced in the second direction D2, thereby limiting displacement of the second movable pressure barrier 52 in the second direction D2. Also, the housing 12 may define a land 60 configured to engage with the second flange 56 when the second movable pressure barrier 52 is displaced in the first direction D1, thereby limiting displacement of the second movable pressure barrier 52 in the first direction D1.

In embodiments wherein one or both of the first and second pressure barriers 42, 52 are first and second flexible bellows 42′, 52′, for example, as shown in FIG. 4B, respective portions of the respective flexible bellows 42′, 52′ may inherently function as first and second travel limiters in the directions of extension and compression of the respective flexible bellows 42′, 52′, as would be recognized by one skilled in the art. For example, respective innermost segments 42′A, 52′A of the first and second flexible bellows 42′, 52′ may be configured to contact the respective first and second lands 50, 60 when the first and second flexible bellows 42′, 52′ are extended and thus limit the extension thereof. Also, the respective innermost segments 42′A, 52′A of the first and second flexible bellows 42′, 52′ and intervening segments 42′B, 52′B of the first and second flexible bellows 42′, 52′ may be configured to stack up against respective outermost segments 42′C, 52′C of the first and second flexible bellows 42′, 52′ when the first and second flexible bellows 42′, 52′ are compressed. As shown in FIG. 4B, the direction of extension of the first flexible bellows 42′ is the second direction D2, and the direction of compression of the first flexible bellows 42′ is the first direction D1. As also shown in FIG. 4B, the direction of extension of the second flexible bellows 52′ is the first direction D1, and the direction of compression of the second flexible bellows 52′ is the second direction D2.

As mentioned above, the first armature 62 includes a first magnet 64, and the second armature 70 includes a second magnet 72. As shown, the first magnet 64 surrounds and is generally coaxial with the second magnet 72. Also, as best shown in, for example, FIGS. 1 and 2, respectively, the first magnet 64 is axially offset from the second magnet 72 in the first direction D1 when the first armature 62 and the second armature 70 are in their respective first positions, and the first magnet 64 is axially offset from the second magnet 72 in the second direction D2 when the first armature 62 and the second armature 70 are in their respective second positions. More specifically, a magnetic center of the first magnet 64 is axially offset from a magnetic center of the second magnet 70 in the first direction D1 when the first and second armatures 62, 70 are in their respective first positions, and the magnetic center of the first magnet 64 is axially offset from the magnetic center of the second magnet 70 in the second direction D2 when the first and second armatures 62, 70 are in their respective second positions.

As suggested above, the first and second magnets 62, 70 cooperate to define a biasing mechanism configured to simultaneously bias both the first and second armatures 62, 70 (and, therefore the first and second multi-port valves they respective define) toward their respective first positions or their respective second positions. More specifically, the first and second magnets 64, 72 are configured so that a magnetic field between the first and second magnets 64, 72 causes the first and second magnets 64, 72 to repel each other at least axially. The strength of the magnetic field and, therefore, the repulsive force, is greatest when the magnetic centers of the first and second magnets 62, 70 are nearest to each other. Conversely, the strength of the magnetic field and, therefore, the repulsive force, is lowest when the magnetic centers of the first and second magnets 62, 70 are farthest from each other. As such, the magnetic field biases the first and second armatures 62, 70 toward their respective first positions when the first magnet 64 is axially offset from the second magnet 72 in the first direction D1. Similarly, the magnetic field biases the first and second armatures 62, 70 toward either their respective second positions when the first magnet 64 is axially offset from the second magnet 72 in the second direction D2. Thus, in the absence of other forces acting on the first and second armatures 62, 70, the first and second armatures 62, 70 are stable when both of the first and second armatures 62, 70 are in either their respective first positions or their respective second positions. The respective field strengths of the first and second magnets 64, 72 may be selected as desired as factors contributing to the oscillation frequency of the flow oscillator 10, as would be recognized by one skilled in the art. As shown, the first and second magnets 64, 72 are located at generally central portions of the first and second armatures 62, 70, respectively. In embodiments, the first and second magnets 64, 72 could be located elsewhere with respect to the first and second armatures 62, 70, respectively, with the magnetic centers of the first and second magnets 64, 72 configured to interact with each other as described above. For example, the first and second magnets 64, 72 could be located proximate the respective first ends or second ends of the first and second armatures 62, 70. In embodiments, the foregoing magnetic biasing mechanism could be replaced with another magnetic biasing mechanism or a non-magnetic biasing mechanism configured to simultaneously bias the first and second armatures 62, 70 towards their respective first positions or their respective second positions.

As mentioned above, the volumes of the first and second pilot chambers as described above, the selection of optional orifices in and or all of the first, second, third, and fourth fluid channels 30, 32, 34, 36 and the exhaust channel(s) 20C, and the magnetic field strength between the first and second magnets 64, 72 are factors that contribute to the oscillation frequency of the oscillator 10. Other factors may contribute to the oscillation frequency of the oscillator 10, including without limitation: the respective sizes of the fluid supply port 14, the first and second bi-directional ports 16, 18, and the fluid exhaust port(s) 20; the respective sizes of the first and second apertures 44, 54; the respective clearances between the second armature 70 and the first and second apertures 44, 54; the clearance between the second armature 70 and the portion of the housing 12 defining the second armature chamber 24; the respective clearances between the first armature 62 and the portions of the housing 12 defining the corresponding adjacent ends of the first and second flow channels 30, 32; and the movable surface area of the first and second movable pressure barriers 42, 52. One skilled in the art would understand how to select at least the foregoing components or features in order to achieve a desired oscillation frequency of the oscillator 10, as will be discussed further below.

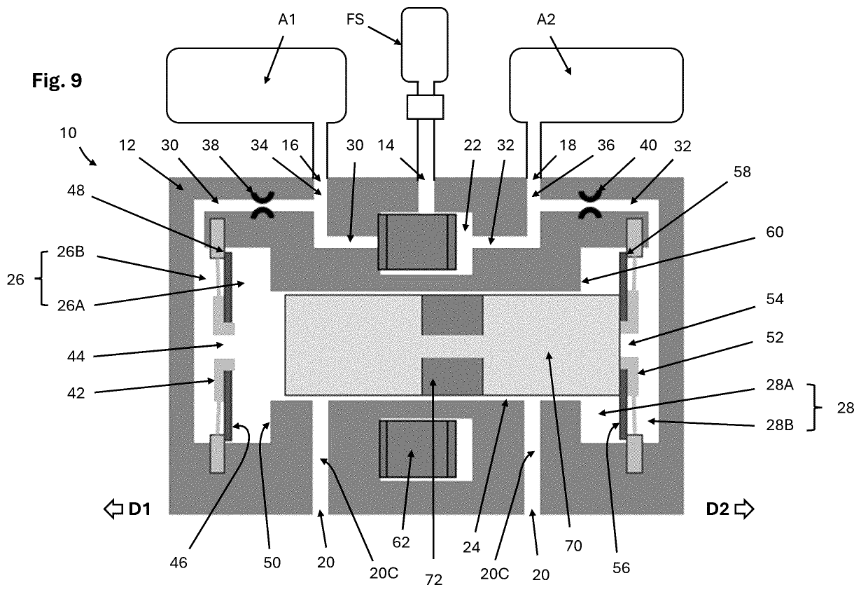

As best shown in FIGS. 9 and 10, the oscillator 10 is configured for use in connection with a source of pressurized fluid FS in fluid communication with the fluid supply port 14, a first external accumulator A1 in fluid communication with the first bi-directional fluid port 16, and a second external accumulator A2 in fluid communication with the second bi-directional fluid port 18. The pressurized fluid may be a liquid or a gas, for example, air. The first and second external accumulators A1, A2 may be, without limitation, first and second selectively inflatable compartments of a therapeutic support surface overlay (not shown). One skilled in the art would recognize that the respective volumes and internal flow characteristics of the first and second external accumulators A1, A2, as well the respective volumes and flow characteristics of fluid conduits connecting the first and second external accumulators A1, A2, respectively, to the first and second bidirectional ports 16, 18 are factors that may contribute to the oscillation frequency of the flow oscillator 10.

FIG. 9 shows the oscillator 10 in a first, stable state, with no fluid flowing from the source of pressurized fluid FS and with the first and second external accumulators A1, A2 at an ambient pressure. In this first, stable state, the first and second armatures 62, 70 are in their respective first positions and are biased to their respective first positions by the magnetic biasing force between the first and second magnets 64, 72. As such, the first armature 62 enables fluid flow from the first armature chamber 22 into the second fluid channel 32 and, therefore, to the second pilot chamber 28B, the fourth fluid channel 36, and the second bi-directional fluid port 18, while blocking fluid flow from the first armature chamber 22 into the first fluid channel 30 and, therefore, to the first pilot chamber 26B, the third fluid channel 34, and the first bi-directional fluid port 16. Also, the second armature 70 enables flow from the first fluid channel 30 through the first aperture 44 of the first movable pressure barrier 42, while resisting or blocking flow from the second fluid channel 32 through the second aperture 54 of the second movable pressure barrier 52. Thus, in this first, stable state, the interior portion of the housing 12 including the second armature chamber 24, the first pilot chamber 26B, and the first and third fluid channels 30, 34 are vented via the exhaust port 20 to an environment, for example, the atmosphere, surrounding the oscillator 10 and thus are at an ambient pressure.

FIG. 10 shows the oscillator 10 in a second, stable state, with no fluid flowing from the source of pressurized fluid FS and with the first and second external accumulators A1, A2 at an ambient pressure. In this second, stable state, the first and second armatures 62, 70 are in their respective second positions and are biased to their respective second positions by the magnetic biasing force between the first and second magnets 64, 72. As such, the first armature 62 blocks fluid flow from the first armature chamber 22 into the second fluid channel 32 and, therefore, to the second pilot chamber 28B, the fourth fluid channel 36, and the second bi-directional fluid port 18, while enabling fluid flow from the first armature chamber 22 into the first fluid channel 30 and, therefore, to the first pilot chamber 26B, the third fluid channel 34, and the first bi-directional fluid port 16. Also, the second armature 70 blocks flow from the first fluid channel 30 through the first aperture 44 of the first movable pressure barrier 42, while enabling flow from the second fluid channel 32 through the second aperture 54 of the second movable pressure barrier 52. Thus, in this second, stable state, the interior portion of the housing 12 including the second armature chamber 24, the second pilot chamber 28B, and the second and fourth fluid channels 32, 36 are vented via the exhaust port 20 to an environment, for example, the atmosphere, surrounding the oscillator 10 and thus is at an ambient pressure.

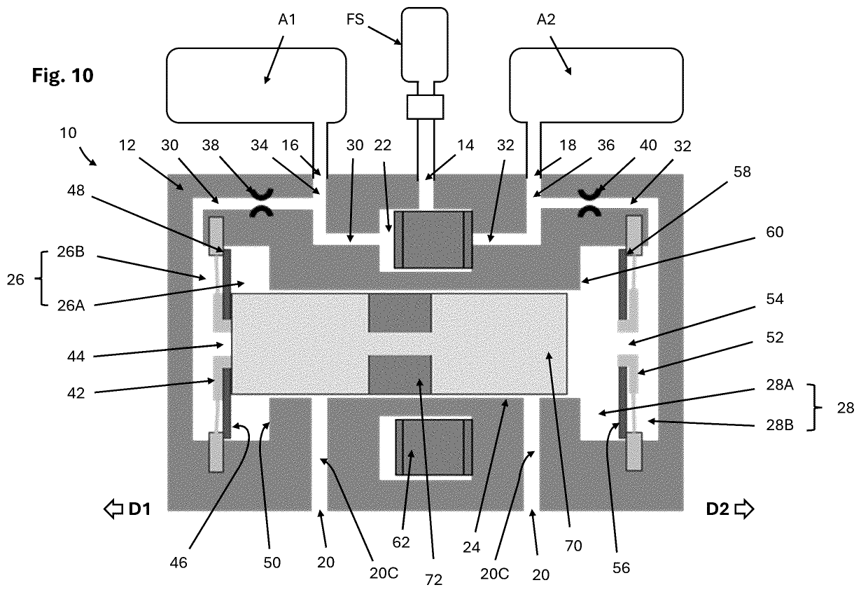

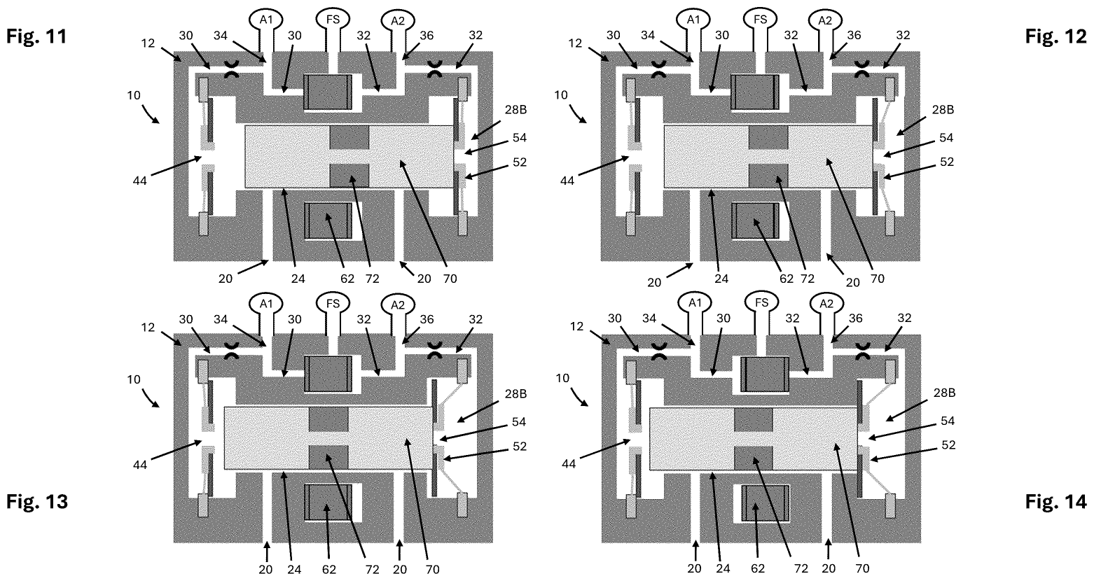

FIGS. 11-18 show the oscillator 10 connected to and receiving pressurized fluid from the source of pressurized fluid FS and selectively directing the pressurized fluid to or relieving the pressurized fluid from the first and second external accumulators A1, A2 in various operational states.

FIG. 11 shows the oscillator 10 in a first initial pressurization state, wherein the first and second armatures 62, 70 are in their respective first positions, as discussed further above and shown in FIG. 9. In this state, the oscillator 10 receives pressurized fluid from the source of pressurized fluid FS via the fluid supply port 14 and directs the pressurized fluid to: (i) the second pilot chamber 28B via the first armature chamber 22 and the second fluid channel 32; and (ii) the second external accumulator A2 via the first armature chamber 22, the second and fourth fluid channels 32, 36 and the second bi-directional fluid port 18. The foregoing flow of pressurized fluid causes the fluid pressures within the second external accumulator A2 and the second pilot chamber 28B to increase. One skilled in the art would recognize that the second and fourth channels 32, 36, and the second flow-restricting orifice 40 (if provided) may be configured so that the pressurized fluid enters the second pilot chamber 28B at a similar rate or at a substantially different rate (for example, more slowly) than that at which it enters the second external accumulator A2 and, therefore, that the fluid pressure within the second pilot chamber 28B increases at a similar rate or a substantially different rate than does the fluid pressure within the second external accumulator A2. Also, in the first initial pressurization state of FIG. 11, the first armature 62 disables flow from the first armature chamber 22 to and downstream of the first fluid channel 30 and, therefore, disables flow of pressurized fluid from the source of pressurized fluid FS to the first accumulator A1 and the first pilot chamber 26B. Further, the second armature 70 blocks fluid flow through the second aperture 54 and enables fluid flow through the first aperture 44, thereby enabling flow of pressurized fluid from the first external accumulator A1 through the fluid exhaust port(s) 20 via the third fluid channel 34, the first fluid channel 30, the first pilot chamber 26B, the second armature chamber 24 and the fluid exhaust channel(s) 20C.

FIG. 12 shows the oscillator 10 in a first intermediate pressurization state similar to the first initial pressurization state of FIG. 11 wherein the first armature 62 remains in its first position, but wherein increasing fluid pressure within the second chamber 28B has caused the second movable pressure barrier 52 to move in the first direction D1 and thereby displace the second armature 70 in the first direction D1. Consequently, the magnetic center of the second magnet 72 has been displaced in the first direction D1 toward, but not to, the magnetic center of the first magnet 64. Therefore, the repulsive magnetic force between the first magnet 64 and the second magnet 72 continues to bias the first magnet 64 (and thus the first armature 62) in the first direction D1, and to bias the second magnet 72 (and thus the second armature 70) in the second direction D2. (Because the first and second magnets 64, 72 are closer together in the first intermediate pressurization state of FIG. 12 compared to the first initial pressurization state of FIG. 11, the repulsive magnetic biasing force between the first and second magnets 64, 72, is greater in the first intermediate pressurization state FIG. 12 state than in the first initial pressurization state of FIG. 11, thus increasing the sealing pressure at the interface between the second end of the second armature 70 and the second movable pressure barrier 52.) As such, the alignment of fluid paths within the oscillator 10 remains as in the first initial pressurization state of FIG. 11. It follows that pressurized fluid continues to flow into the second external accumulator A2 and into the second pilot chamber 28B, the first armature 62 continues to disable flow of pressurized fluid from the source of pressurized fluid FS to and downstream of the first fluid channel 30, and the second armature 70 continues to enable fluid flow from the first external accumulator A1 to the environment surrounding the oscillator 10.

FIG. 13 shows the oscillator 10 in a second intermediate pressurization state similar to the first intermediate pressurization state of FIG. 12 wherein the first armature 62 remains in its first position, but wherein increasing fluid pressure within the second pilot chamber 28B has caused the second movable pressure barrier 52 to move further in the first direction D1 and thereby displace the second armature 70 further in the first direction D1 than in the first intermediate pressurization state of FIG. 12. Consequently, the magnetic center of the second magnet 72 has been displaced in the first direction D1 substantially to, but not beyond, the magnetic center of the first magnet 64. (Because the first and second magnets 64, 72 are closer together in the second intermediate pressurization state of FIG. 12 compared to the first intermediate pressurization state of FIG. 12, the magnetic biasing force between the first and second magnets 64, 72, is even greater in the second intermediate pressurization state FIG. 12 state than in the first intermediate pressurization state of FIG. 12, thus further increasing the sealing pressure at the interface between the second end of the second armature 70 and the second movable pressure barrier 52.) In this state, the magnetic biasing force between the first magnet 64 and the second magnet 72 destabilizes the first magnet 64 with respect to the second magnet 72. Notwithstanding, in the second intermediate pressurization state of FIG. 13, the alignment of fluid paths with the oscillator 10 remains as in the first initial pressurization state of FIG. 11. As such, pressurized fluid continues to flow into the second external accumulator A2 and into the second pilot chamber 28B, the first armature 62 continues to disable flow of pressurized fluid from the source of pressurized fluid FS to and downstream of the first fluid channel 30, and the second armature 70 continues to enable fluid flow from the first external accumulator A1 to the environment surrounding the oscillator 10.

FIG. 14 shows the oscillator 10 in a first transition state wherein the oscillator 10 transitions between the states shown in FIGS. 9 and 10, respectively. More specifically, FIG. 14 shows the oscillator 10 in a state wherein continued increasing fluid pressure within the second pilot chamber 28B has caused the second movable pressure barrier 52 to move still further in the first direction D1 (to the greatest extent permitted by the interaction of the second 56 with the land 60) and to thereby displace the second armature 70 still further in the first direction D1 than in the second intermediate pressurization state of FIG. 13. As shown in FIG. 14, the magnetic center of the second magnet 72 has been displaced in the first direction D1 beyond the magnetic center of the first magnet 64. As such, the direction of the magnetic biasing force between the first magnet 64 and the second magnet 72 has been reversed so that the magnetic biasing force biases the first magnet 64 in the second direction D2, and so that it biases the second magnet 72 in the first direction D1. Indeed, FIG. 14 shows the first armature 62 having been biased to its second position as shown in FIG. 10, and it shows the second armature 70 being biased toward, but not having been biased to, its second position.

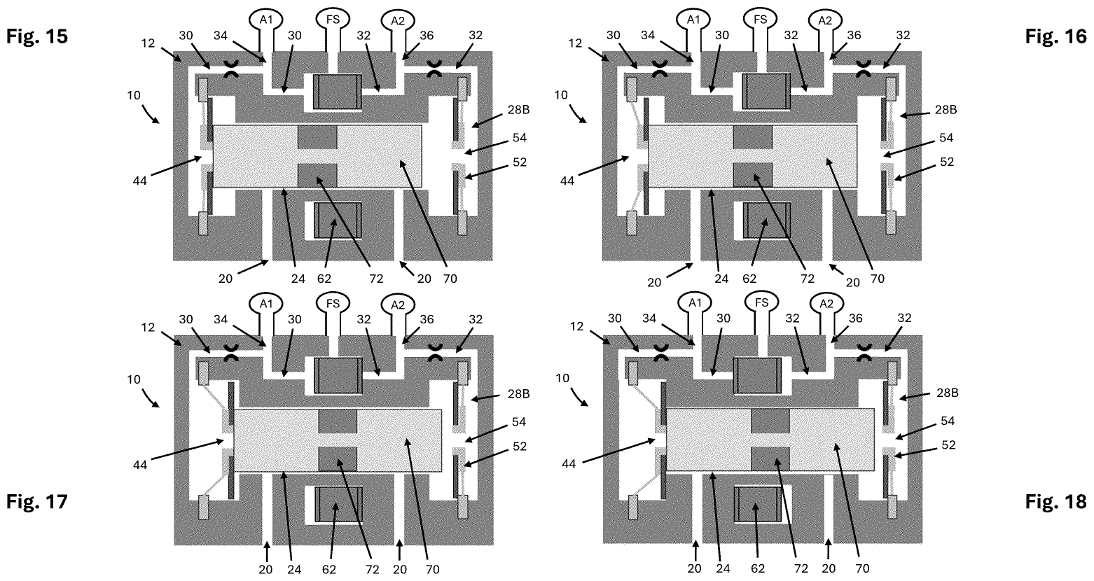

FIG. 15 shows the oscillator 10 in a second initial pressurization state, wherein the first and second armatures 62, 70 are in their respective second positions, as discussed further above and shown in FIG. 10. In this state, the oscillator 10 receives pressurized fluid from the source of pressurized fluid FS via the fluid supply port 14 and directs the pressurized fluid to: (i) the first pilot chamber 26B via the first armature chamber 22 and the first fluid channel 30; and (ii) the first external accumulator A1 via the first armature chamber 22, the first fluid channel 30, the third fluid channel 34, and the first bi-directional fluid port 16. The foregoing flow of pressurized fluid causes the fluid pressures within the first external accumulator A1 and the first pilot chamber 26B to increase. One skilled in the art would recognize that the first and third fluid channels 30, 34, and the first flow-restricting orifice 38 (if provided) may be configured so that the pressurized fluid enters the first pilot chamber 26B at a similar rate or at a substantially different rate (for example, more slowly) than it enters the first external accumulator A1 and, therefore, that the fluid pressure within the first pilot chamber 26B increases at a similar rate or a substantially different rate than does the fluid pressure within the first external accumulator A1. Also, in the second initial pressurization state of FIG. 15, the first armature 62 disables flow from the first armature chamber 22 to the second fluid channel 32 and, therefore, disables flow of pressurized fluid from the source of pressurized fluid FS to the second external accumulator A2 and the second pilot chamber 28B. Further, the second armature 70 blocks fluid flow through the first aperture 44 and enables fluid flow through the second aperture 54, thereby enabling flow of pressurized fluid from the second external accumulator A2 through the fluid exhaust port(s) 20 via the fourth fluid channel 36, the second fluid channel 32, the second pilot chamber 28, the second armature chamber 24 and the fluid exhaust channel(s) 20C.

FIG. 16 shows the oscillator 10 in a third intermediate pressurization state similar to the second initial pressurization state of FIG. 11 wherein the first armature 62 remains in its second position, but wherein increasing fluid pressure within the first pilot chamber 26B has caused the first movable pressure barrier 42 to move in the second direction D2 and thereby displace the second armature 70 in the second direction D2. Consequently, the magnetic center of the second magnet 72 has been displaced in the second direction D2 toward, but not to, the magnetic center of the first magnet 64. Therefore, the magnetic force between the first magnet 64 and the second magnet 72 continues to bias the first magnet 64 (and thus the first armature 62) in the second direction D2, and to bias the second magnet 72 (and thus the second armature 70) in the first direction D1. (Because the first and second magnets 64, 72 are closer together in the third intermediate pressurization state of FIG. 16 compared to the second initial pressurization state of FIG. 15, the magnetic biasing force between the first and second magnets 64, 72, is greater in the third intermediate pressurization state FIG. 16 state than in the second initial pressurization state of FIG. 15, thus increasing the sealing pressure at the interface between the second end of the second armature 70 and the second movable pressure barrier 52.) As such, the alignment of fluid paths within the oscillator 10 remains as in the second initial pressurization state of FIG. 15. It follows that pressurized fluid continues to flow into the first external accumulator A1 and into the first pilot chamber 26B, the first armature 62 continues to disable flow of pressurized fluid from the source of pressurized fluid FS to and downstream of the second fluid channel 32, and the second armature 70 continues to enable fluid flow from the second external accumulator A2 to the environment surrounding the oscillator 10.

FIG. 17 shows the oscillator 10 in a fourth intermediate pressurization state similar to the third intermediate pressurization state of FIG. 16 wherein the first armature 62 remains in its second position, but wherein increasing fluid pressure within the first pilot chamber 26B has caused the first movable pressure barrier 42 to move further in the second direction D2 and thereby displace the second armature 70 further in the second direction D2 than in the third intermediate pressurization state of FIG. 16. Consequently, the magnetic center of the second magnet 72 has been displaced in the second direction D2 substantially to, but not beyond, the magnetic center of the first magnet 64. (Because the first and second magnets 64, 72 are closer together in the fourth intermediate pressurization state of FIG. 17 compared to the third intermediate pressurization state of FIG. 16, the magnetic biasing force between the first and second magnets 64, 72, is even greater in the fourth intermediate pressurization state FIG. 17 than in the third intermediate pressurization state of FIG. 16, thus further increasing the sealing pressure at the interface between the second end of the second armature 70 and the second movable pressure barrier 52.) In this state, the magnetic biasing force between the first magnet 64 and the second magnet 72 destabilizes the first magnet 64 with respect to the second magnet 72. Notwithstanding, in the fourth intermediate pressurization state of FIG. 17, the alignment of fluid paths with the oscillator 10 remains as in the second initial pressurization state of FIG. 15. As such, pressurized fluid continues to flow into the first external accumulator A1 and into the first pilot chamber 26B, the armature 62 continues to disable flow of pressurized fluid from the source of pressurized fluid FS to and downstream of the second fluid channel 32, and the second armature 70 continues to enable fluid flow from the second external accumulator A2 to the environment surrounding the oscillator 10.

FIG. 18 shows the oscillator 10 in a second transition state wherein the oscillator 10 transitions between the states shown in FIGS. 10 and 9, respectively. More specifically, FIG. 18 shows the oscillator 10 in a state wherein continued increasing fluid pressure within the first pilot chamber 26B has caused the first movable pressure barrier 42 to move still further in the second direction D2 (to the greatest extent permitted by the interaction of the first travel limiter 46 with the land 50) and to thereby displace the second armature 70 still further in the second direction D2 than in the fourth intermediate pressurization state of FIG. 17. As shown in FIG. 18, the magnetic center of the second magnet 72 has been displaced in the second direction D2 beyond the magnetic center of the first magnet 64. As such, the direction of the magnetic biasing force between the first magnet 64 and the second magnet 72 has been reversed so that the magnetic biasing force biases the first magnet 64 in the first direction D1, and so that it biases the second magnet 72 in the second direction D2. Indeed, FIG. 18 shows the first armature 62 having been biased to its first position as shown in FIG. 9, and it shows the second armature 70 being biased toward, but not having been biased to, its second position. Following the second transition state of FIG. 18, the oscillator 10 returns to the first initial pressurization state of FIG. 11.

One skilled in the art would understand how to set the frequency of oscillation of the oscillator 10 as shown, for example, in FIGS. 11-18 as a function of various factors, for example, the fluid supply pressure, the sizes of the first and second accumulators A1, A2, and the movable surface area, the thickness, and the material of the first and second movable pressure barriers 42, 52, among others. The frequency of oscillation could be symmetric (the dwell time in position 1 may be the same as the dwell time in position 2) or asymmetric (the dwell time in position 1 may be different than the dwell time in position 2).

Also, one skilled in the art would recognize that the pressurization period and frequency for the first external accumulator A1 is a function of the rate of pressurization of the first pilot chamber 26B, and that the pressurization period and frequency for the second external accumulator A2 is a function of the rate of pressurization of the second pilot chamber 28B, among other factors. As such, one skilled in the art would recognize that the pressurization period and frequency of the first and second external accumulators A1, A2 may be selected as desired and that the pressurization period and frequency of the first external accumulator A1 may be the same as or different from the pressurization period and frequency of the second external accumulator A2. One skilled in the art would recognize that the oscillator 10 could be configured to charge either or both of the first and second external accumulators A1, A2 to pressures higher than the first and/or second pilot chamber 26B, 28B transition pressures by appropriate selection of, for example without limitation, the magnetic field strength(s) of the first and second magnets 64, 72 (and thus the biasing force between the first and second magnets 64, 72), the material and movable surface area of the first and/or second movable pressure barriers 42, 52, and the size of one or more internal fluid channels and and/or flow-restricting orifices within the oscillator 10.

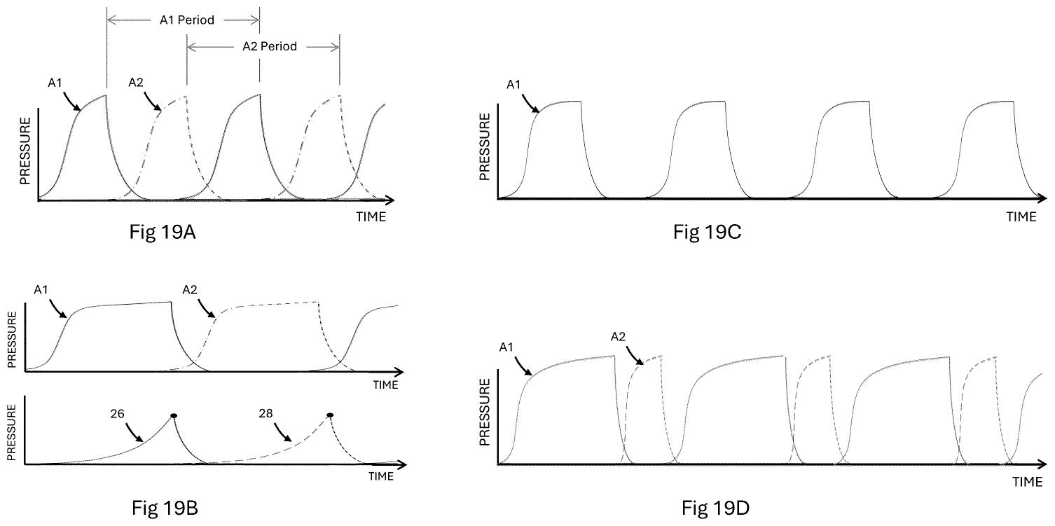

FIGS. 19A-19D are timing diagrams showing illustrative pressurization and venting of ones of the first and second external accumulators A1, A2 resulting from illustrative oscillations of the oscillator 10 as functions of time. More specifically, FIG. 19A shows timing of pressurization and venting of the first and second external accumulators A1, A2 as a function of time according to a first illustrative embodiment further to corresponding oscillation of the oscillator 10, wherein the pressurization period and frequency of the first external accumulator A1 is the same as the pressurization period and frequency of the second external accumulator A2. FIG. 19B shows timing of pressurization and venting of the first and second external accumulators A1, A2 as a function of time according to a second illustrative embodiment further to corresponding oscillation of the oscillator 10, wherein the pressurization period and frequency of the first external accumulator A1 is the same as the pressurization period and frequency of the second external accumulator A2. FIG. 19B also shows timing of corresponding pressurization and venting of the first and second pilot chambers 26B, 28B of the oscillator 10 according to the second illustrative embodiment. FIG. 19C shows timing of pressurization and venting of the first external accumulator A1 as a function of time according to a third illustrative embodiment further to corresponding oscillation of the oscillator 10. In the FIG. 19C embodiment, the second external accumulator A2 is omitted and the second bi-directional fluid port 18 is omitted or plugged. FIG. 19D shows timing of pressurization and venting of the first and second external accumulators A1, A2 as a function of time according to a fourth illustrative embodiment further to corresponding oscillation of the oscillator 10, wherein the pressurization period and frequency of the first external accumulator A1 is different from the pressurization period and frequency of the second external accumulator A2.

As mentioned above, either or both of the first and second bidirectional ports 16, 18 may be omitted or plugged. In such embodiments, the respective one or ones of the first and second external accumulators A1, A2 also would be omitted. In such embodiments, the operation of the flow oscillator 10 may similar to that described above, except that the flow control valve would not communicate fluid with the omitted one or ones of the first and second external accumulators A1, A2, and the structures of the omitted or plugged one or ones of the first and second bidirectional ports 16, 18 and the omitted one or ones of the first and second external accumulators A1, A2 (and associated fluid conduits) would not be factors contributing to the oscillation frequency of the oscillator 10. Accordingly, in such embodiments, the size of the pilot chambers corresponding to the omitted or plugged one(s) of the first and second bidirectional ports 16, 18, as discussed further above, and the size(s) of the flow restrictors corresponding to the omitted or plugged one(s) of the first and second bidirectional ports 16, 18 may be particularly relevant to (and may be the predominant factors in) achieving desired oscillation frequency characteristics for the oscillator 10, as would be understood by one skilled in the art.

As also mentioned above, either or both of the first and second bidirectional ports 16, 18 may deadheaded, for example without limitation, by plugging a respective one or ones of fluid conduits connected thereto, external to the housing 12. In such embodiments, the structures of the deadheaded one or ones of the first and second bidirectional ports 16, 18 and the fluid conduits connected thereto may remain factors contributing to the oscillation frequency of the oscillator 10. Nevertheless, in such embodiments, the size of the pilot chamber 26B, 28B corresponding to the omitted or plugged one(s) of the first and second bidirectional ports 16, 18 and the size(s) of the flow restrictors corresponding to the omitted or plugged one(s) of the first and second bidirectional ports 16, 18 may be particularly relevant to (and may be the predominant factors in) achieving desired oscillation frequency characteristics for the oscillator 10, as discussed further above, and as would be understood by one skilled in the art.

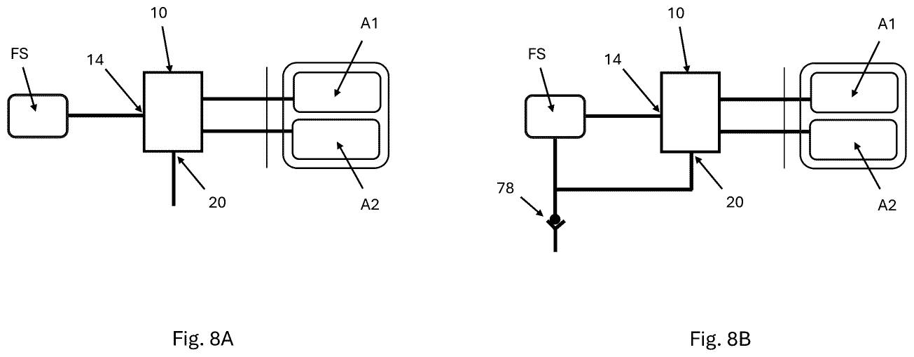

The foregoing description of operation of the oscillator 10 is directed to an embodiment wherein the exhaust port 20 is fluidly coupled to an environment surrounding the oscillator 10, and wherein the environment may be the atmosphere at ambient pressure. In embodiments, the exhaust port 20 may by fluidly coupled to an environment other than the atmosphere which may be at a pressure other than ambient pressure. For example, as shown in FIG. 8B, the exhaust port 20 may be coupled to an environment at a pressure greater than ambient pressure or less than ambient pressure, for example, a vacuum. In an embodiment, the source of pressurized fluid FS could be a fluid pump, for example a pneumatic pump, having a fluid inlet and a fluid outlet. The fluid inlet port 14 of the oscillator 10 could be fluidly coupled to the fluid outlet of the fluid pump, and the exhaust port 20 of the oscillator 10 could be fluidly coupled to the fluid inlet of the fluid pump. Thus, the fluid pump could draw a vacuum on the exhaust port 20 of the oscillator 10, while simultaneously providing pressurized fluid to the fluid inlet port 14 of the oscillator 10. Such an arrangement may facilitate evacuation of one or more external accumulators, for example, one or both of the first and second external accumulators A1, A2, connected to one or both of the bidirectional ports 16, 18 during operation of the oscillator 10. A vacuum breaker, for example, a calibrated check valve, could be provided in fluid communication with the pump inlet to provide make up fluid to the pump inlet. In any event, the pressure at the exhaust port 20 would be lesser than the pressure of the fluid provided to the fluid inlet port 14.

The embodiments shown and described herein are illustrative and not limiting. Those skilled in the art would understand how to modify the illustrative embodiments without departure from the scope of the appended claims.

1. An oscillating flow controller comprising:
a housing;
a first valve operable between a first position and a second position;
a second valve operable between a first position and a second position; and
a biasing mechanism configured to simultaneously bias both of the first valve and the second valve toward their respective first positions or toward their respective second positions,
wherein the housing, the first valve, and the second valve cooperate to define a first pilot chamber and a second pilot chamber,
wherein the first valve is configured to: (i) disable fluid communication through a first fluid inlet into the first pilot chamber and enable fluid communication through a second fluid inlet into the second pilot chamber when the first valve is in the first position; and (ii) enable fluid communication through the first fluid inlet into the first pilot chamber and disable fluid communication through the second fluid inlet into the second pilot chamber when the first valve is in the second position,
wherein the second valve is configured to: (i) enable fluid communication through a first fluid outlet from the first pilot chamber and disable fluid communication through a second fluid outlet from the second pilot chamber when the second valve is in the first position; and (ii) disable fluid communication through the first fluid outlet from the first pilot chamber and enable fluid communication through the second fluid outlet from the second pilot chamber when the second valve is in the second position.

2. The oscillating flow controller of claim 1,
wherein the first valve comprises a first armature having a first and a second end movably received within a first armature chamber defined by the housing,
wherein the first armature is configured to move between first and second positions within the first armature chamber,
wherein, when the first armature is in the first position, the first end of the first armature cooperates with the housing to disable fluid communication through the first fluid inlet from the first armature chamber to the first pilot chamber, and the second end of the first armature cooperates with the housing to enable fluid communication through the second fluid inlet to the second pilot chamber,
wherein, when the first armature is in the second position, the first end of the first armature cooperates with the housing to enable fluid communication through the first fluid inlet from the first armature chamber to the first pilot chamber, and the second end of the first armature cooperates with the housing to disable fluid communication between the first armature chamber and the second fluid inlet,
wherein the second valve comprises:
a second armature having a first and a second end movably received within a second armature chamber defined by the housing;
a first pressure barrier defining a first aperture and movable between a first position and a second position; and
a second pressure barrier defining a second aperture and movable between a first position and a second position,
wherein the second armature is configured to move between first and second positions within the second armature chamber,
wherein, when the second armature is in the first position, the first end of the second armature cooperates with the first pressure barrier to enable fluid communication through the first aperture from the first pilot chamber to the second armature chamber, and the second end of the second armature cooperates with the second pressure barrier to disable fluid communication through the second aperture from the second pilot chamber to the second armature chamber, and
wherein, when the second armature is in the second position, the first end of the second armature cooperates with the first pressure barrier to disable fluid communication through the first aperture from the first pilot chamber to the second armature chamber, and the second end of the second armature cooperates with the second pressure barrier to enable fluid communication through the second aperture from the second pilot chamber to the second armature chamber.

3. The oscillating flow controller of claim 2, wherein the first pressure barrier and the second pressure barrier are configured to move in response to movement of the second armature.

4. The oscillating flow controller of claim 2, wherein the second armature is configured to move in response to movement of one of the first pressure barrier and the second pressure barrier.

5. The oscillating flow controller of claim 4, wherein the second armature is configured to move in response to movement of the other one of the first pressure barrier and the second pressure barrier.

6. The oscillating flow controller of claim 2 wherein introduction of a pressurized fluid to the second fluid inlet when the first and second valves are in their respective first positions causes the second pressure barrier to move and thereby move the second armature toward its second position.

7. The oscillating flow controller of claim 6, wherein the biasing mechanism, in response to the movement of the second armature toward its second position, biases the first armature and the second armature toward their respective second positions.

8. The oscillating flow controller of claim 2 wherein introduction of a pressurized fluid to the first fluid inlet when the first and second valves are in their respective second positions causes the first pressure barrier to move and thereby move the second armature toward its first position.

9. The oscillating flow controller of claim 8, wherein the biasing mechanism, in response to the movement of the second armature toward its first state, biases the first armature and the second armature toward their respective first positions.

10. The oscillating flow controller of claim 2, wherein the first pressure barrier and/or the second pressure barrier is flexible and resilient.

11. The oscillating flow controller of claim 2, wherein the first pressure barrier and/or the second pressure barrier is a diaphragm.

12. The oscillating flow controller of claim 2, wherein the first pressure barrier and/or the second pressure barrier is a bellows.

13. The oscillating flow controller of claim 2, wherein the biasing mechanism comprises a first magnet connected to the first armature and a second magnet connected to the second armature, wherein the first magnet and the second magnet are configured to repel each other.

14. The oscillating flow controller of claim 2, wherein the first armature surrounds the second armature.

15. The oscillating flow controller of claim 2, wherein the first armature chamber surrounds the second armature chamber, and wherein a portion of the housing separates the first armature chamber from the second armature chamber.

16. The oscillating flow controller of claim 1 further comprising a first flow restrictor located in the first pilot chamber between the first valve and the second valve, wherein the first flow restrictor divides the first pilot chamber into a first section proximate the first valve and a second section proximate the second valve.

17. The oscillating flow controller of claim 1, wherein the housing further defines a first bidirectional port in fluid communication with the first pilot chamber, wherein the first bidirectional port is configured for connection to a first external accumulator.

18. The oscillating flow controller of claim 17 further comprising a first flow restrictor located in the first pilot chamber between the first valve and the second valve, wherein the first flow restrictor divides the first pilot chamber into a first section proximate the first valve and the first bidirectional port and a second section distant from the first valve and the first bi-directional port.

19. The oscillating flow controller of claim 17, wherein the housing further defines a second bidirectional port in fluid communication with the second pilot chamber, wherein the second bidirectional port is configured for connection to a second external accumulator.

20. The oscillating flow controller of claim 1 further comprising a travel limiter connected to the first movable pressure barrier and configured to limit movement of the first moveable pressure barrier with respect to the first pilot chamber or the second armature.

21. A system comprising the oscillating flow controller of claim 1, further comprising a fluid pump having a fluid outlet fluidly coupled to the first and second fluid inlets of the oscillating flow controller and a fluid inlet fluidly coupled to the first and second fluid outlets of the oscillating flow controller.
